(19) United States
(12) Patent Application Publication
(10) Pub. No.: US 2024/0424565 A1
(43) Pub. Date: Dec. 26, 2024

(54) METHOD FOR PRODUCING A COMPONENT, AND CORRESPONDINGLY PRODUCED COMPONENT

(71) Applicant: Linde GmbH, Pullach (DE)

(72) Inventors: Karlmann KANZLER, Pullach (DE); Georg WIMMER, Pullach (DE); Christian Michael HERWERTH, Pullach (DE); Felix ARMBRÜSTER, Pullach (DE)

(21) Appl. No.: 18/710,855

(22) PCT Filed: Nov. 24, 2022
(86) PCT No.: PCT/EP2022/025536

§ 371 Date: May 16, 2024

(30) Foreign Application Priority Data
Nov. 25, 2021 (EP) 21020593.6

(51) Int. Cl. B22F 10/80; B33Y 10/00; B33Y 50/00; B33Y 80/00; F28F 9/18

(52) U.S. Cl. CPC B22F 10/80; B33Y 10/00; B33Y 50/00; B33Y 80/00; F28F 9/182; B22F 2998/10; F28F 2275/06

(57) ABSTRACT

A method of producing a component for a technical device which has a base structure and one or more supplemental structures. The base structure is not additively manufactured, the one or more supplemental structures is/are applied onto the base structure by means of an additive manufacturing process, and the base structure is subjected to a deformation during the additive manufacturing process. The base structure is provided with a starting shape which is selected such that the deformation leads to a desired target shape of the base structure. The invention likewise relates to a corresponding component.

The invention relates to a method for producing a component for a technical device and to a component for a technical device.

### BACKGROUND

Technical devices such as machines, apparatuses, or systems, or their individual components are often exposed to high loads during operation. For instance, high loads can occur in components of a technical device through which fluid flows on account of the fluids guided through the component. For example, process media for carrying out heat exchange are supplied and discharged by headers of a heat exchanger, e.g., a brazed plate-fin heat exchanger. Such components, or the walls thereof, therefore often have to withstand high pressures, stresses, and further loads. For example, the walls of pressure vessels can also be exposed to such high loads—for example, in vessels for storing substances under positive or negative external or internal pressure.

For the dimensioning of such components, a position of the highest load on the component can be assumed, for example. The wall thickness of the component at this position can be selected such that the wall can withstand the high loads at that location. In conventional manufacturing methods, this position with the highest loads defines the wall thickness of the entire component.

However, it is also possible to produce a simple base structure of a component with a minimum required wall thickness and specifically reinforcing or stiffening said base structure at certain positions that are exposed to increased mechanical stresses by applying material by means of an additive manufacturing process. The same is disclosed in WO 2022/073640 A1 of the applicant. The regions or positions of the base structure to be reinforced can be determined by an optimization method or an optimization algorithm.

WO 2016/001360 A1 proposes providing a prefabricated component for a motor vehicle at specific locations with additively manufactured reinforcing structures and in this way preventing or deflecting deformation in the event of an accident. WO 2017/021440 A1 also proposes the additive application of reinforcing structures to a prefabricated component, wherein the component is held in a mold in order to prevent deformation during the additive manufacturing process. In contrast, the manufacture of a component by means of purely additive manufacturing is known, for example, from U.S. Pat. No. 11,022,967 B2.

In other words, a base structure can be provided for producing a component and supplemented by a supplemental structure by means of an additive manufacturing process. The supplemental structure is applied to the base structure by means of an additive manufacturing process and is thereby integrally connected thereto.

The object of the present invention is to improve the production of components, which take place in a corresponding manner, partially by means of an additive manufacturing process.

### DISCLOSURE OF THE INVENTION

Against this background, the present invention proposes a method for producing a component for a technical device, and a component for a technical device, having the features of the independent claims. Each of the embodiments are the subject matter of the dependent claims and of the description below.

During the production of a component in the manner explained at the outset, i.e., in a method in which a base structure is provided and supplemented by means of an additive manufacturing process with a supplemental structure, and in which the supplemental structure is applied to the base structure by means of an additive manufacturing process and is thereby integrally bonded to the base structure, deformations in the material can occur due to the additive manufacturing process (particularly in processes in which a heat input into the base structure takes place, e.g., in the case of application welding methods), which deformations require a complex aftertreatment following the additive manufacturing process in order to achieve a target shape or compensate for the deformations.

The invention is based then upon the finding that corresponding aftertreatment can be avoided if the deformation caused by additive manufacturing is predicted, and a shape of the component present before carrying out the additive manufacturing, hereafter also referred to as an initial shape, and the manner of the additive manufacturing process are selected such that the component has the target shape after the additive manufacturing process. The component, provided with the supplemental structure and with the target shape, i.e., in particular, without further deformation of the component, can then be installed in an arrangement a part of which is the component. One embodiment of the invention therefore also comprises a production of an arrangement using the component.

In contrast to methods of the prior art, a deformation of a component in the additive manufacturing process is therefore explicitly permitted, and not minimized or prevented in a complicated manner. The deformation is thus an integral part of the manufacturing method, in order to achieve the desired final shape. Unlike, for example, in the method described in WO 2017/021440 A1, a holder in a shape which prevents deformation during the additive manufacturing process and which withstands the considerable deformation forces, and therefore has to be produced with sufficient stability, is therefore not required. The manufacturing is overall simpler and more cost-effective.

Overall, the invention proposes a method for producing a component for a technical device which has a base structure and one or more supplemental structures. The one or more supplemental structures are applied to the base structure by additive manufacturing, and the base structure is subjected to deformation during the additive manufacturing process. The base structure is thereby provided with a starting shape which is selected such that the deformation leads to a desired target shape of the base structure. The deformation can in particular be a stress deformation, caused by thermal stresses in the additive manufacturing process.

In the context of the method proposed here, a base structure of the component (hereafter, only the singular is used for the sake of simplicity, wherein the corresponding explanations also relate to a plurality of existing components) can be manufactured with a predefined wall thickness. At least one region of the component—expediently, at least one region to be reinforced—can be determined or identified or located by means of an optimization method. In this at least one region, a reinforcing structure can be applied to the base structure by means of an additive manufacturing method. In the language used below, this reinforcing structure is a supplemental structure, because it supplements the base structure accordingly. A (voltage) deformation caused by the additive manufacturing process can thereby be influenced by a (further) supplemental structure in the desired manner. The latter, which does not have or need not have a reinforcing effect, is a structure which only serves to compensate for deformations. It is hereafter also referred to as the compensation structure. As mentioned, all elements can be present in a plurality, but are described in singly, in a simplified manner, below.

The base structure expediently represents a basic volume or a first material volume. The reinforcing structure represents in particular an additional volume or a second material volume. The reinforcing structure represents in particular a further additional volume or a third material volume. The entire component or a total volume of the component is thus formed by the base structure or the base volume and the reinforcing structure applied thereto, and the compensation structure or its additional volume.

The base structure is or was not manufactured additively, wherein the proposed method can comprise the manufacture of the base structure. It can be produced, for example, by means of a manufacturing method by primary forming or reshaping. In the usual understanding of the person skilled in the art, primary forming is accordingly understood to mean a group of manufacturing methods in which a solid body is produced from a shapeless substance, which body has a geometrically defined shape. Primary forming is used to produce the initial shape of a solid body and create the material cohesion. In particular, the primary forming can take place from the liquid or plastic state—in particular, by a casting method such as gravity, pressure, low-pressure, centrifugal, or continuous casting, or by compressive or draw-forming. A reshaping can in particular comprise hot or cold forming, or sheet metal or massive forming, or a compressive, tensile-compressive, bending, or shear forming. The present invention is not limited to a specific, non-additive manufacturing process.

Non-additive is a corresponding manufacturing method in particular if in this case no step-by-step material application takes place, e.g., in more than 2, 3, 4, 5, or 10 steps, but, rather, the manufacture takes place in particular by providing a component or partial component having a substantially already desired final shape (or a shape present before the deformation), wherein, however, the succession of method steps, such as primary forming and then reshaping, or the joining together of different corresponding workpieces, e.g., by welding or pressing, is not ruled out. In particular, a non-additive manufacturing process is carried out in several layers without melting or powder application.

For example, in the course of the proposed method, an entire wall defining the component can be produced as a single piece. Likewise, individual partial walls can also be produced separately, e.g., by means of such manufacturing methods as primary forming or reshaping, and combined to form all the walls of the component, e.g., by means of a joining method—for example, a welding method.

In particular, the wall thickness of the base structure can be predefined as the smallest possible—in particular, minimum—wall thickness, which is expediently designed for a low load acting upon the component or which at least requires the base structure in order to be able to withstand the acting loads. The base structure is then specifically reinforced by the supporting structure at locations with higher loads, so that the component can also withstand the higher loads acting at these locations. The reinforcing structure can thus be applied in a targeted manner to particularly stressed positions of the component, and the component can be individually adapted to the load case in question. As mentioned, the compensating structure serves, in particular, only to compensate for deformations, but does not necessarily provide a fixing effect.

In other words, in embodiments of the invention, a plurality of supplemental structures can be applied to the base structure by means of an additive manufacturing process, wherein the plurality of supplemental structures comprise one or more reinforcing structures and one or more compensation structures, wherein, as mentioned, the reinforcing structures in particular represent supplemental structures that increase stability of the component at one or more points, and the compensating structures, in particular, represent supplemental structures which do not necessarily increase stability, but cause a desired deformation. The reinforcing structures are therefore applied on the basis of a specification strength of the component, and the compensating structures are applied on the basis of a deformation prediction. More generally, “first” and “second” supplemental structures are also referred to in this context.

The additive manufacturing method makes it possible to apply the reinforcing structure or a first supplemental structure and the compensating structure or a second supplemental structure precisely, and thus to generate precise local reinforcements of the base structure and influences in the deformation. Additive manufacturing is a production method in which a three-dimensional object or a three-dimensional structure is produced by consecutively adding a material layer-by-layer. One after the other, a new material layer is applied, solidified, and firmly bonded to the underlying layers—for example, by means of a laser, electron beam, or electric arc.

In the context of the present method, the regions or points at which the reinforcing structure or first supplemental structure or the compensating structure or second supplemental structure are to be applied to the base structure can be determined or identified or located by means of the optimization method or a corresponding optimization algorithm. Generally speaking, optimization methods or optimization are generally understood to be analytical or numerical calculation methods for discovering optimized—in particular, minimized or maximized—parameters of a complex system.

In one embodiment of the present invention, the deformation can be predicted using a prediction method while obtaining prediction data, and a material application during the additive manufacturing process can be performed based upon the prediction data. In such a configuration, the invention allows a particularly targeted, precise material application.

The prediction method can in particular comprise the use of a finite element method and/or an optimization algorithm. Corresponding methods can also be carried out for determining the material application required for the reinforcing structure.

In one optimization problem, a scope for solutions Ω, i.e., a number of possible solutions or variables [symbol] and a target function ƒ, could be specified. To solve this optimization problem, a set of values of the variables or solutions [symbol] ∈Ω is sought, so that ƒ( [symbol] ) fulfills a predefined criterion—for example, maximum or minimum. Furthermore, constraints or secondary conditions can also be predefined, wherein permissible solutions [symbol] have to meet these predefined constraints. In the present case, to solve the optimization problem, for example, a target function can be defined such that the total wall thickness of the component is minimized as far as possible.

Particularly expediently, the optimization method can be carried out as a function of a numerical solution—in particular, using the aforementioned finite element method. The finite element method is a numerical method based upon the numerical solution of a complex system of partial differential equations. The base structure or a different component is divided into a finite number of sub-regions of simple shape, i.e., into finite elements of which the physical or thermo-hydraulic behavior can be calculated on the basis of their simple geometry. In each of the finite elements, the partial differential equations are replaced by simple differential equations or by algebraic equations. The system of equations thus obtained is solved in order to obtain an approximate solution of the partial differential equations. During the transition from one element into the adjacent element, the physical behavior of the entire body is simulated by predetermined continuity conditions. Such a finite element method is particularly advantageous for carrying out an optimization method. For example, in the context of the present method, for each of the individual finite elements, it can be examined whether they are to be filled with a corresponding material as part of the base structure or supporting structure.

Advantageously, the optimization method is carried out as a function of a simulation of the base structure and the additive manufacturing process—in particular, by a numerical simulation. In particular, a static or dynamic simulation can be carried out—for example, a thermo-mechanical strength simulation. By means of the simulation, the component or the entire technical device together with the component can be reproduced theoretically. The behavior of the component during the additive manufacturing and the stresses, loads, etc., acting upon the component can be simulated. In particular, quantities and positions of the material applied as a compensating structure can be changed in the course of the simulation in order to investigate the behavior of the component under different conditions. In this way, the component can be divided into a plurality of individual regions as part of the optimization method, and it can be determined individually for these regions whether material is to be applied in each of these regions by means of additive manufacturing.

The present method provides an advantageous possibility for generating a partially additively manufactured component. The base structure can be produced non-additively in a cost-effective and material-saving manner. The use of the additive manufacturing method can be reduced, such that costs and material can also be saved in this regard. The component can be manufactured cost-effectively, with material savings and reduced weight and can be optimally adapted to the subsequent application and its area of use. The application of the compensating structure makes it possible, in particular, to dispense with subsequent post-processing for achieving a target shape and for reverse reshaping.

In one embodiment of the invention, the reinforcing structure or at least one of the plurality of reinforcing structures, and the compensating structure or at least one of the plurality of compensation structures, or, in other words, the first supplemental structure(s) and the second supplemental structure(s), can be applied simultaneously or in a staggered manner by means of an additive manufacturing process. Particular in the case of a staggered application, after the application of the reinforcing structure or at least one of the plurality of reinforcing structures, i.e., the first supplemental structure(s), the deformation can be determined, and the application of the compensating structure or at least one of the plurality of compensation structures, i.e., the second supplemental structure(s), can be carried out as a function thereof. This makes it possible to respond with precision to the actually occurring deformations.

According to a particularly preferred embodiment, the supplemental structure(s) is/are applied to the base structure by means of wire arc additive manufacturing (WAAM). In the course of this method, individual layers are produced by means of a consumable wire and an arc. For this purpose, welding torches, e.g., for gas-shielded metal-arc welding, can be used, in which an arc burns between the welding torch and the component to be produced. A corresponding material is continuously fed in, e.g., in the form of a wire or strip, and melted by the arc. This causes molten droplets to form, which transition onto the workpiece to be produced and firmly connect thereto. The particular material can be supplied, for example, as a consumable wire electrode of the welding torch, wherein the arc burns between this wire electrode and the component. It is also conceivable to supply the material in the form of an additional wire which is melted by the arc of the welding torch.

Alternatively or additionally, further additive manufacturing methods can be used, in the course of which the material of the supporting structure or of the additional volume is applied, e.g., in powder form or in the form of wires or strips, and is applied by means of a laser and/or electron beam. In this way, the material can be subjected, for example, to a sintering or melting process in order to be solidified. After producing a layer, the next layer can be produced in an analogous manner. Additive manufacturing methods of this type include, for example, selective laser sintering (SLS), selective laser melting (SLM), electron beam melting (EBM), stereolithography (SL) or fused deposition modeling (FDM), or fused filament fabrication (FFF).

Alternatively or additionally, additive manufacturing methods can also be used for which no laser beam, electron beam, or arc is used. Preferably, the supporting structure can be applied to the base structure by means of cold spray (CS) or gas dynamic cold spray. In the course of this process, the material is applied, for example, in powder form at high speed. For this purpose, a process gas, such as nitrogen or helium, which is heated to a few hundred degrees, can be accelerated, e.g., by expansion, to supersonic speed. The powder particles of the material can be injected into the gas jet so that they are accelerated to high speed and form a firmly adhering layer upon impact with the base structure.

In embodiments of the invention, the base structure, the reinforcing structure, and the compensating structure (or a portion of these components) can be manufactured from the same material—for example, from aluminum or an aluminum alloy. Furthermore, the base structure, the reinforcing structure, and the compensating structure (or a portion of two of these components) can also be manufactured from different materials. The materials for the base structure, the reinforcing structure, and the compensation structure can each be selected, for example, on the basis of their specific material properties, and/or on the basis of specific component requirements, or on the basis of the specific loads acting upon the component and deformations of the same.

In embodiments of the invention, the base structure, the reinforcing structure, and the compensating structure (or a portion of these components) can be made of materials of similar or dissimilar type—in particular, of aluminum materials or aluminum alloys. Materials “of similar type” or “of the same type” are to be understood in particular to be materials which have an identical or comparable structure and/or an identical or comparable thermal expansion, which, in contrast, is not the case with materials “of dissimilar type” or “of different type.” Materials of similar type are, for example, different carbon steels. In contrast, carbon steel and stainless steel are, for example, of dissimilar type, due to the different material structure (structure and thermal expansion). The term “materials of similar type” can also be understood to mean various aluminum alloys which, due to the diversity of possible alloys, lead to large differences in mechanical and thermal characteristics. An example of materials of dissimilar type may be the bonding of an aluminum material to a (stainless) steel material, which are commonly understood to be “incompatible.” Expediently, it is therefore possible to use specifically materials of the same or a different type with other properties to construct the base structure, the reinforcing structure, and the compensation structure (or two of these components). In particular, a material of the supplemental structure—in particular, of the compensation structure—can be a material having known or particularly advantageous deformation properties.

In embodiments of the invention, the component is a component of a process engineering apparatus, a pressure vessel, or a lightweight component of a land vehicle or aircraft. The present invention is suitable for a number of different fields of application and for the production of components for various technical devices used in process, regulation, and/or control engineering. In the present context, a technical device is to be understood in particular as a unit or a system of different units for carrying out a technical process—in particular, a process, regulation, and/or control engineering process. The technical device can advantageously be designed as a machine, i.e., in particular as a device for energy or force conversion, and/or as an apparatus, i.e., in particular a device for substance or material conversion. Furthermore, the technical device can also be designed in particular as a system, i.e., in particular as a system of a plurality of components, which may each be machines and/or apparatuses, for example.

According to one embodiment, the component is a component through which fluid flows or can flow of a technical device. Preferably, the component is a component for a pressure vessel or is itself a pressure vessel. Such a pressure vessel can be provided in particular for storing a substance under positive or negative internal or external pressure. Pressure vessels can be exposed to high alternating pressure loads.

Although reference was made at the outset to process engineering equipment such as heat exchangers and pressure vessels, embodiments of the present invention are not limited to usage in corresponding technical fields, but are basically applicable in the manufacture of other components—in particular, structural components—for example, in apparatus and container construction, but also in other fields in which additive manufacturing is used—for example, for lightweight construction in aircraft or vehicle construction.

In one embodiment of the invention, the component is a header with nozzle of a plate-fin heat exchanger (PFHE)—for example, of a soldered-on, plate-fin heat exchanger made of aluminum (brazed aluminum plate-fin heat exchanger, PFHE; designations according to the German and English edition of ISO 15547-2:3005). Plate heat exchangers of this type have a plurality of stacked partition plates and lamellae, as well as cover plates, edge strips or side bars, distributors, or headers. Furthermore, pipe sections or pipelines for supplying and discharging individual media are provided. Such elements can be exposed to high loads during operation of the heat exchanger, e.g., high temperatures or temperature differences as well as high pressures and mechanical stresses, and are therefore particularly suitable for being produced according to the present method.

The base shape can in particular be a non-complex, easily producible shape, which is selected in particular from a cylindrical shape, a spherical shape, a hemispherical shape, a dome shape, a plate shape, and partial shapes thereof. The production is particularly simple, due to the combined manufacture. The base shape can in particular also be selected from a round or polygonal tube, or a solid profile which can be deformed in a targeted manner by a corresponding material application.

A component for a technical device, which has a base structure and one or more supplemental structures, wherein the base structure is not additively manufactured, and the one or more supplemental structures are applied to the base structure by means of an additive manufacturing process, and the base structure has been subjected to a deformation during the additive manufacturing, is likewise the subject matter of the present invention. The base structure was provided with a starting shape which was selected such that the deformation has led to a desired target shape of the base structure. The supplemental structures comprise one or more reinforcing structures and one or more compensating structures.

In addition to the method for producing a component, the present invention thus further relates also to a component for a technical device, which is produced in particular according to the present method. Embodiments of this component according to the invention result analogously from the above description of the method according to the invention.

Further advantages and embodiments of the invention arise from the description and the accompanying drawings.

It is to be understood that the features mentioned above and those still to be explained below may be used not only in the particular combination specified, but also in other combinations or by themselves, without departing from the scope of the present invention.

The invention is schematically represented in the drawings using exemplary embodiments and will be described in detail below with reference to the drawings.

### DESCRIPTION OF THE FIGURES

FIG. 1 shows a heat exchanger in a simplified isometric representation.

FIGS. 2A to 2C illustrate aspects of the present invention.

In the figures, components corresponding functionally or structurally to one another are indicated by identical reference signs, and only for the sake of clarity are not repeatedly explained. Explanations relating to method steps relate to device features in the same way, and vice versa.

### DETAILED DESCRIPTION OF THE DRAWINGS

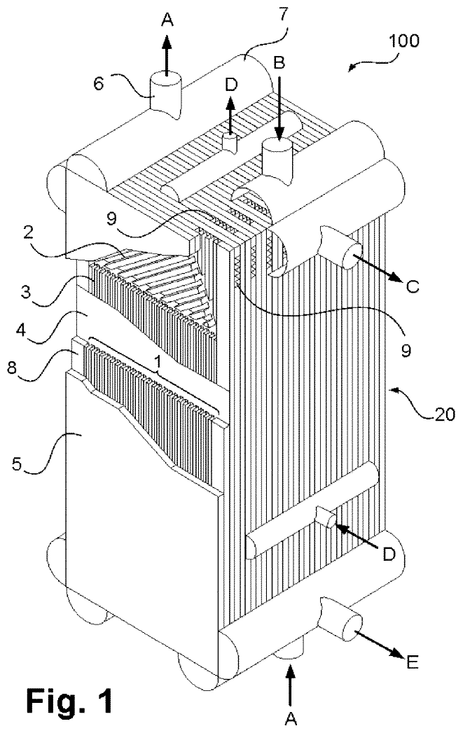

FIG. 1 is a schematic representation of a heat exchanger, which is denoted by 100. The heat exchanger represents a technical device, wherein individual elements or components of the heat exchanger 100—in particular, through which fluid flows—in particular, the header 7 and nozzle 6 thereof—are manufactured in a particularly advantageous manner according to one embodiment of the invention.

The heat exchanger 100 shown in FIG. 1 is a brazed plate-fin heat exchanger made of aluminum (PFHE) (designations according to the German and English edition of ISO 15547-2:3005), as can be used in a large number of systems at very different pressures and temperatures. For example, they are used in cryogenic air separation, in the liquefaction of natural gas, and in ethylene production plants. It is understood that “aluminum” can also denote an aluminum alloy.

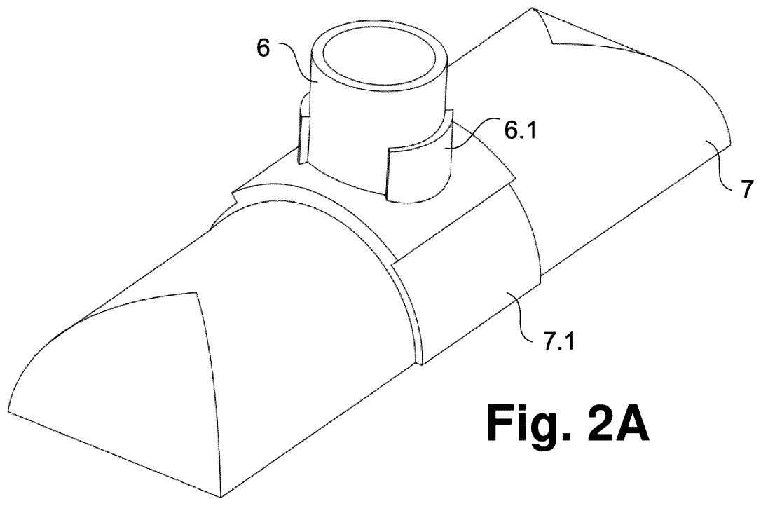

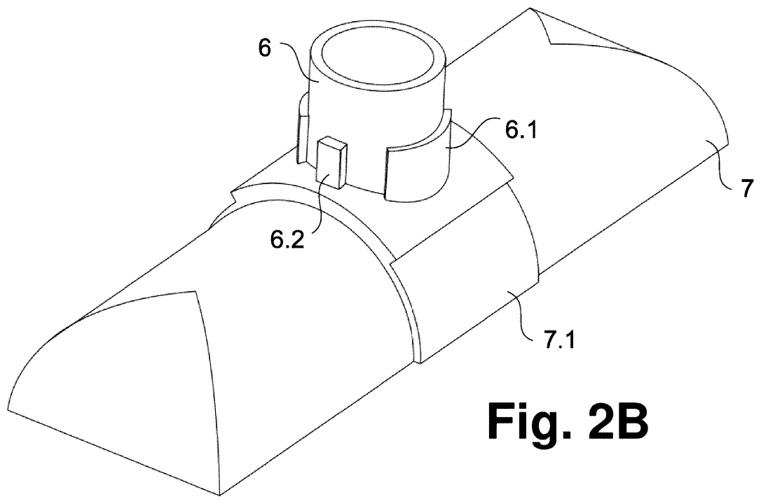

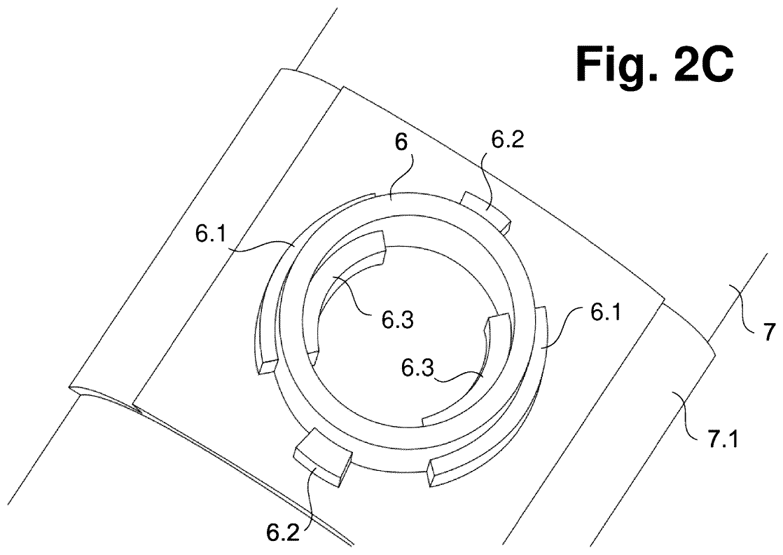

Brazed plate-fin heat exchangers made of aluminum are shown and described in FIG. 2 of the above-mentioned ISO 15547-2:3005, as well as on page 5 of the ALPEMA publication, “The Standards of the Brazed Aluminum Plate-Fine Heat Exchanger Manufacturers' Association”, 3rd edition, 2010. The present FIG. 1 substantially corresponds to the illustrations of the aforementioned ISO standard and will be explained below in order to explain the background of the invention.

The plate heat exchanger 100, shown partially opened in FIG. 1, is used for the heat exchange of five different process media A to E in the example shown. For heat exchange between the process media A to E, the plate heat exchanger 100 comprises a plurality of separating sheets 4 arranged in parallel with one another (in the previously mentioned publications, to which the subsequent references in brackets also refer, these are called “parting sheets”), between which heat exchange passages 1 defined by structural sheets with lamellae 3 (“fins”) are formed—in each case for one of the process media A to E—and which can thereby come into heat exchange with one another.

The structural sheets with the lamellae 3 are typically folded or corrugated, and flow channels are formed by each of the folds or corrugations, as also shown in FIG. 1 of the ISO 15547-2:3005. The provision of the structural sheets with lamellae 3 offers the advantage of improved heat transfer, more targeted fluid guidance, and an increase in the mechanical (tensile) strength in comparison with plate heat exchangers without lamellae. In the heat exchange passages 1, the process media A to E flow, in particular separated by the separating sheets 4, but can optionally pass through the latter with lamellae 3 in the case of perforated structural sheets.

The individual passages 1 or the structural sheets with the lamellae 3 are surrounded on each side by what are known as side bars 8, which leave space free for feed and removal openings 9, however. The side bars 8 hold the separating sheets 4 at a distance and ensure mechanical reinforcement of the pressure chamber. Cover sheets 5 (“cap sheets”), which are in particular reinforced, are arranged in parallel with the separating sheets 4 and are used in particular to close off at least two sides.

By means of what are known as headers 7, which are provided with nozzles 6, the process media A to E are supplied and discharged via feed and removal openings 9. In the inlet region of the passages 1, there are further structural sheets with what are known as distributor lamellae 2 (“distributor fins”), which ensure uniform distribution over the entire width of the passages 1. As seen in the direction of flow, further structural sheets with distributor lamellae 2 can be located at the end of the passage 1, and lead the process media A to E from the passages 1 into the header 7, where they are collected and withdrawn via the corresponding nozzles 6.

A heat exchanger block 20, which is cuboid in this case, is formed overall by the structural sheets with the lamellae 3, the further structural sheets with the distributor lamellae 2, the side bars 8, the separating sheets 4 and the cover sheets 5, wherein a “heat exchanger block” is to be understood here as the stated elements without the headers 7 and nozzles 6 in an interconnected state. As not illustrated in FIG. 1, the plate heat exchanger 100 can—in particular, for manufacturing reasons—be formed from a plurality of corresponding cuboidal and interconnected heat exchanger blocks 20.

Corresponding plate heat exchangers 100 are brazed from aluminum. The individual passages 1, comprising the structural sheets with the lamellae 3, the further structural sheets with the distributor lamellae 2, the cover sheets 5, and the side bars 8, are in this case each provided with solder, stacked one on top of the other or arranged accordingly, and heated in an oven. The header 7 and the nozzles 6 are welded onto the heat exchanger block 20 produced in this way.

The headers 7 are produced in the conventional way—for example, using semi-cylindrical extruded profiles which are brought to the required length and are then welded onto the heat exchanger block 20. In this case, the header 7 is often manufactured with a constant wall thickness, and this wall thickness is oriented to the position of the highest utilization.

In contrast thereto, the present method makes it possible to produce, for example, headers 7 with nozzles 6 in a manner that is cost-effective and saves upon material—in particular, with a varying wall thickness which is specifically adapted to the individually present load case. This is accomplished by partially additive manufacturing, wherein deformations are particularly advantageously compensated for as explained below.

FIG. 2A to 2C illustrate aspects of the present invention, wherein in each case a header, as denoted above by 7, with nozzle 6 is illustrated here. The header is designed at least in one portion in the shape of a semicircular tube. This portion can in particular be produced with a constant wall thickness and consistently of the same material.

However, in the terminology used here, a tubular piece which forms the nozzle 6 is a base structure which, according to embodiments of the invention, also must be a different component. Supplemental structures in the form of reinforcing structures 6.1 are applied to the base structure, i.e., the header 6 in the present example, by means of an additive manufacturing process. As further illustrated, the header 7 itself is also provided with corresponding reinforcing structures 7.1 in order to stabilize it.

FIGS. 2A and 2B illustrate in particular different stages of a multi-stage manufacturing method. As can be seen from the overview of FIGS. 2A and 2B, further supplemental structures in the form of compensating structures 6.2 described above, which structures produce a deformation, are applied in the example illustrated here after the application of the reinforcing structures 6.1, which also produce a deformation. The type, location, and material of the compensation structures 6.2 are selected in such a way that the deformation produced by the application of the reinforcing structures 6.1 is compensated for by the application thereof, and a target shape is achieved.

As can be seen from FIGS. 2B and 2C—again, in an overview—compensating structures 6.2 can be provided by means of the additive manufacturing process on the outer circumference of the base structure, i.e., of the nozzle 6, and in the interior thereof—here denoted by 6.3. FIG. 2C is a view from above of or into the nozzle 6.

1. A method for producing a component for a technical device which has a base structure and one or more supplemental structures, wherein the base structure has not been or is not additively manufactured, the one or more supplemental structures is/are applied onto the base structure by means of an additive manufacturing process, and the base structure is subjected to a deformation during the additive manufacturing process, wherein the base structure is provided with a starting shape which is selected such that the deformation leads to a desired target shape of the base structure.

2. The method according to claim 1, wherein a material application in which the deformation is predicted using a prediction method while obtaining prediction data, and a material application during the additive manufacturing process is performed based upon the prediction data.

3. The method according to claim 2, wherein the prediction method comprises the use of a finite element method and/or an optimization algorithm.

4. The method according to claim 2, wherein one or more locations and/or one or more amounts of the material application are determined on the basis of the prediction data.

5. The method according to claim 1, wherein a plurality of supplemental structures are applied to the base structure by means of the additive manufacturing process, wherein the supplemental structures comprise one or more first supplemental structures and one or more second supplemental structures.

6. The method according to claim 5, wherein the first supplemental structure or at least one of the plurality of first supplemental structures and the second supplemental structure or at least one of the plurality of second supplemental structures is/are applied simultaneously or in a staggered manner by means of the additive manufacturing process.

7. The method according to claim 6, in which, after application of the first supplemental structure or at least one of the plurality of first supplemental structures, the deformation is determined, and the application of the second supplemental structure or at least one of the plurality of second supplemental structures is carried out as a function thereof.

8. The method according to claim 1, in which the component is a component of a process engineering apparatus, of a pressure vessel, or a lightweight component of a land vehicle or aircraft.

9. The method according to claim 8, wherein the component is a nozzle, attached to a header, of a plate-fin heat exchanger.

10. The method according to claim 1, in which the basic shape is selected from a cylindrical shape, a spherical shape, a semi-spherical shape, a dome shape, a plate shape, and partial shapes thereof.

11. The method according to claim 1, in which the basic shape is selected from a round or polygonal tube or a solid profile.

12. A component for a technical device having a base structure and one or more supplemental structures, wherein the base structure is not additively manufactured, the one or more supplemental structures is/are applied onto the base structure by means of an additive manufacturing process, and the base structure was subjected to deformation during the additive manufacturing process, wherein the base structure has been provided with a starting shape which was selected such that the deformation has led to a desired target shape of the base structure.
